(19) United States
(12) Patent Application Publication
(10) Pub. No.: US 2002/0073197 A1
(43) Pub. Date: Jun. 13, 2002

(54) Method and apparatus for customizing performance of a browser for a given network connection

(75) Inventors: Kulvir S. Bhogal, Fort Worth, TX (US); Baljeet S. Baweja, Austin, TX (US); Nizamudeen Ishmael JR., Austin, TX (US); Mandeep Sidhu, Austin, TX (US)

Correspondence Address: Duke W. Yee, Carstens Yee & Cahoon, LLP, P.O. Box 802334, Dallas, TX, 75380, US

(73) Assignee: IBM Corporation

(21) Appl. No.: 09/734,825

(22) Filed: Dec. 11, 2000

(51) Int. Cl. G06F 15/173; G06F 15/16

(52) U.S. Cl. 709/224; 709/218

(57) ABSTRACT

A method of customizing performance of a browser for a given network connection of a user, comprising upon launching of the browser, issuing a request to a benchmarking server and returning given data from the benchmarking server to the browser. The given data is used to calculate connection speed data that is passed in a client request to a web server. This connection speed data is then referenced by either the client side or server side to formulate web pages “best” suited for the the connection speed in question.

### BACKGROUND OF THE INVENTION

The present invention relates generally to web browsing and, in particular, to techniques for enabling a web browser to communicate connection information to a web server to customize performance.

The World Wide Web is the Internet's multimedia information retrieval system. In the web environment, a client machine and, in particular, a web browser, effects transactions to web servers using the Hypertext Transfer Protocol (HTTP), which is a known application protocol providing users access to files (e.g., text, graphics, images, sound, video, etc.) using a standard page description language known as Hypertext Markup Language (HTML). HTML provides basic document formatting and allows the developer to specify “links” to other servers and files. In the Internet paradigm, a network path to a server is identified by a so-called Uniform Resource Locator (URL) having a special syntax for defining a network connection. Use of an HTML-compatible browser (e.g., Netscape Navigator or Microsoft Internet Explorer) at a client machine involves specification of a link via the URL. In response, the client makes a request to the server identified in the link and, in return, receives a document or other object formatted according to HTML. A collection of documents supported on a web server is sometimes referred to as a web site.

Techniques for operating at different speeds and under different protocols on the same or different communication media are known in the art. These techniques are implemented on systems that include client-server systems involving the Internet and various telecommunications systems. The systems provide efficient utilization of shared resources but do not dynamically detect various aspects of a client platform at specific times or under varying conditions. There are mechanisms known in the art that use header info to detect various aspects of a client's platform. For example, the Browser Spy and Ultimate JavaScript Sniffer will detect client platform properties. These mechanisms are generally relegated to determining properties such as what applications are being used and the version number of the applications. While these prior art techniques and systems will determine connection properties and can be used to provide for efficient utilization of resources, they do not allow a client to provide specific information which will allow the most suitable version of a web site or page to be sent to the client. Currently web developers are forced to either have the user choose between a high-bandwidth or low-bandwidth based site or design a “one size fits all” web site for all site visitors. This may result in the user getting a version of the web site that is not best suited for the client platform. Furthermore, prior art techniques do not allow for client-side determination of connection data nor allow the client to relay connection data to server sites in a standard.

The present invention addresses these and other deficiencies of the prior art.

### BRIEF SUMMARY OF THE INVENTION

The present invention is a method that enables a client in a client-server system to determine and communicate connection data to a web server in order to obtain the most suitable version of a web site. Upon launching of a browser, or other browser event, the client issues a request to a benchmarking server to test the speed of the connection. The benchmarking server returns data to the client browser that is used to calculate connection speed data. The client can then pass the connection speed data in a client request to a web server to obtain the most suitable version of the web site. The web server uses the connection speed data to specifically tailor the web page for the client connection speed.

The inventive method enables a user to pass the connection speed data in a header of the client request to a web server. Once the client has calculated the connection speed, the client defines a variable, e.g., connection_speed, which is given a value equal to the calculated connection speed. The variable may be passed in the header of the client request to a web server and used by the web server to determine which version of the web site should be sent to the client. Alternatively, it may be passed in the form of a cookie.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference should be made to the following Detailed Description taken in connection with the accompanying drawings in which:

FIG. 1 is a simplified illustration of a client-server environment in which the present invention may be implemented;

FIG. 2 is a detailed illustration of the client-server environment in which the present invention may be implemented;

FIG. 3 is a flowchart illustrating a client-benchmarking server process flow according to the invention;

FIG. 4 is a flowchart illustrating one embodiment affecting a client-server process flow according to the invention;

FIG. 5 is a flowchart illustrating a client request process flow according to the invention.

### DETAILED DESCRIPTION OF THE INVENTION

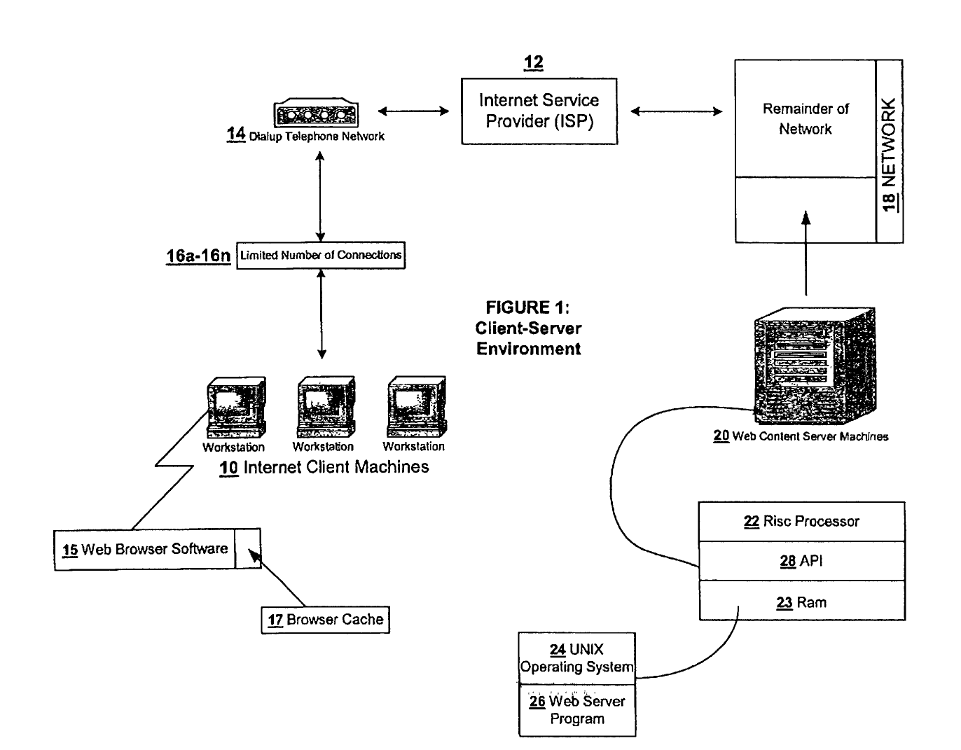

A representative system in which the present invention is implemented is illustrated in FIG. 1. A plurality of Internet client machines 10 are connectable to a computer network Internet Service Provider (ISP) 12 via a network such as a dialup telephone network 14. As is well known, the dialup telephone network usually has a given, limited number of connections 16a-16n. ISP 12 interfaces the client machines 10 to the remainder of the network 18, which includes a plurality of web content server machines 20. Network 18 typically includes other servers (not shown) for control of domain name resolution, routing and other control functions. A client machine typically includes a suite of known Internet tools, including a Web browser, to access the servers of the network and thus obtain certain services. These services include one-to-one messaging (e-mail), one-to-many messaging (bulletin board), on-line chat, file transfer and browsing. Various known Internet protocols are used for these services. Thus, for example, browsing by the cleint machine is effected using the Hypertext Transfer Protocol (HTTP), which provides users access to multimedia files using Hypertext Markup Language (HTML). Other markup languages such as Extensible Markup Language (XML) find application in the web as well. The collection of servers that use HTTP comprise the World Wide Web, which is the Internet's multimedia information retrieval system.

A given client machine and the server may communicate over the public Internet, an Intranet, or any other computer network. If desired, given communications may take place over a secure connection. Thus, for example, a client may communication with the server using a network security protocol, such as the Secure Socket Layer (SSL) or Transport Layer Security protocols or the like.

A representative client is a personal computer, notebook computer, Internet appliance or pervasive computing device (e.g., a PDA or palm computer) that is Pentium-, PowerPC®- or RISC-based. The client includes an operating system such as Linux, Microsoft Windows, Microsoft Windows CE or PalmOS. As noted above, the client includes a suite of Internet tools including a Web browser 15, such as Netscape Navigator or Microsoft Internet Explorer, that has a Java Virtual Machine (JVM) and support for application plug-ins or helper applications. The browser has a cache 17 associated therewith for temporary storage of given content.

A representative web server is an IBM Netfinity server comprising a RISC-based processor 22, a UNIX-based operating system 24 and a web server program 26. OS 24 and web server program 26 are supported in system memory 23 (e.g., RAM). The server may include an application programming interface 28 (API) that provides extensions to enable application developers to extend and/or customize the core functionality thereof through software programs including plug-ins, CGI programs, servlets, and the like. As will be seen, the present invention requires minimum change to the web server functionality. The present invention is a method for enabling a client-side browser to communicate connection information to a web server. In a preferred embodiment, the method is implemented as a computer program, namely, as a set of instructions executed by a processor. Thus, for example, the method may be a Java applet, a browser plug-in, a standalone application written in native code, a distinct process built into the web browser, or part of the integral web browser functionality. Generally, the method allows the user to determine the connection speed and communicate the connection speed to the web server in a header construct. The web server can then download the most suitable version of the web site.

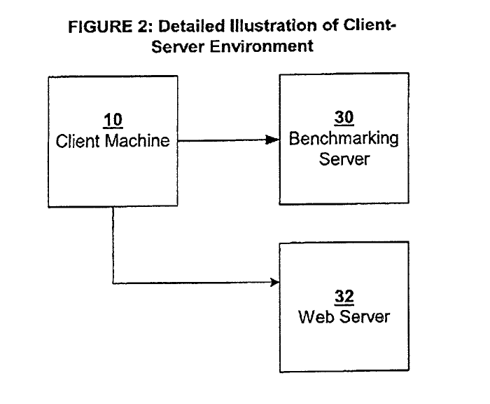

FIG. 2 is a more detailed illustration of the client-server environment in which the present invention is implemented. The client machine 10 interfaces to a benchmarking server 30 and a web server 32. A representative benchmarking server 30 is an IBM Netfinity server comprising a RISC-based processor 22, a UNIX-based operating system 24 and a web server program 26. OS 24 and web server program 26 are supported in system memory 23 (e.g., RAM). It should be appreciated by one skilled in the art that the benchmarking server and web server containing a site requested by the client may be the same server although the servers are illustrated separately.

The client machine 10 will communicate first with the benchmarking server 30 upon loading of the browser application 34. The client machine will request and receive data from the benchmarking server 30 which allows the client machine 10 to determine the connection speed. Once the connection speed is determined, the client machine 10 can then communicate the connection speed to the web server 32 upon request of a web site.

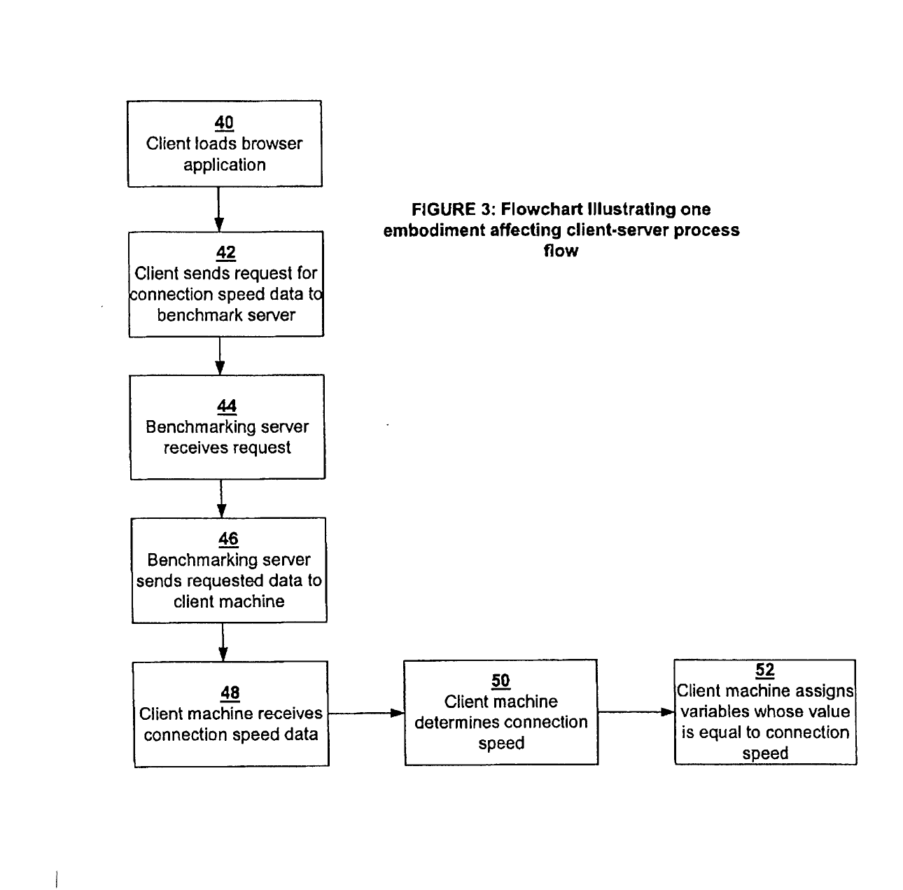

FIG. 3 is a flowchart illustrating a client-benchmarking server process flow according to the present invention. Processing begins at step 40 and continues to step 52 where the browser application is then ready to communicate the connection speed data to the web server. This may occur, for example, at an initial HTTP request to the web server for a first web page of a given web site hosted by the web server. Alternatively, this may occur when the browser 24 is first activated at the client. At step 40, the client loads a browser application 34 (as shown in FIG. 2), such as Netscape Navigator or Microsoft Internet Explorer. The client then sends a request for connection speed data to the benchmarking server at step 42. When the benchmarking server 30 receives the request at step 44, the processing continues at step 46 with the benchmarking server ascertaining and sending the requested data to the client machine. The client machine receives the connection speed data at step 48 and determines a connection speed (step 50). The variable definition process ends at step 52 where the client machine assigns a variable whose value is equal to the connection speed. It should be appreciated that the connection speed data may include any number of data that are relevant in determining the overall connection speed between client and web server. This data could include the relative speeds of the client and web server machines as well as the immediate network around the client and web server in addition to level of traffic on those links currently. In addition, historical data could be used as well. It should also be appreciated that the determination of connection speed can be determined in numerous ways. In one embodiment of the invention, only the client side connection is benchmarked and the measured connection speed is utilized in communication with multiple web sites. In another embodiment of the invention, a combined connection speed calculation is made for a particular client/web server combination and would be used only for requests to that specific web server.

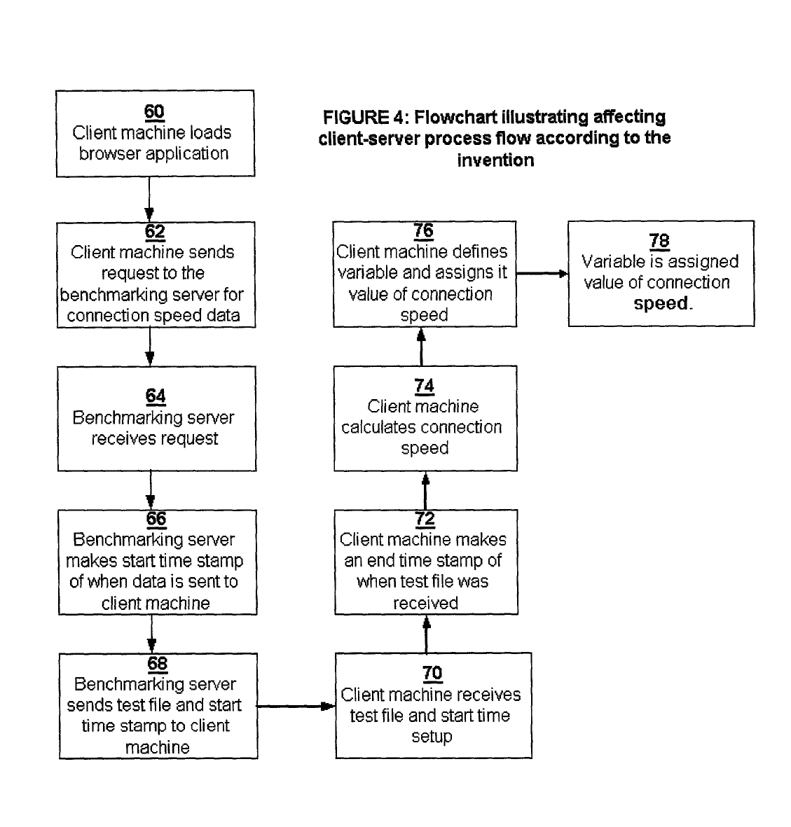

One illustrative embodiment of the present invention utilizes a function that calculates the connection speed from the connection speed data as shown by FIG. 4. At step 60, the client machine loads a browser application and at step 62 sends a request to the benchmarking server for connection speed data. The benchmarking server receives the request (step 64) and makes a start time stamp of when the data is sent to the client machine at step 66. The process continues at step 68 with the benchmarking server sending a test file and the start time stamp to the client machine. The client machine receives the test file and start time stamp and makes an end time stamp of when the test file was received (steps 70 and 72). The client machine, at step 74, utilizes a function that calculates the connection speed based on the test file size and the Delta t or the difference between the start and end time stamps. At step 76, the client machine defines a variable, e.g., connection_speed, which at step 78, is assigned the value of the connection speed. One skilled in the art would appreciate that a similar measurement could be made for the web server. Thus, the measurements for the connection speed of each machine to the benchmarking server could be used to derive an aggregate connection speed. It is envisioned, however, for most circumstances that the client side mesurement will be sufficient.

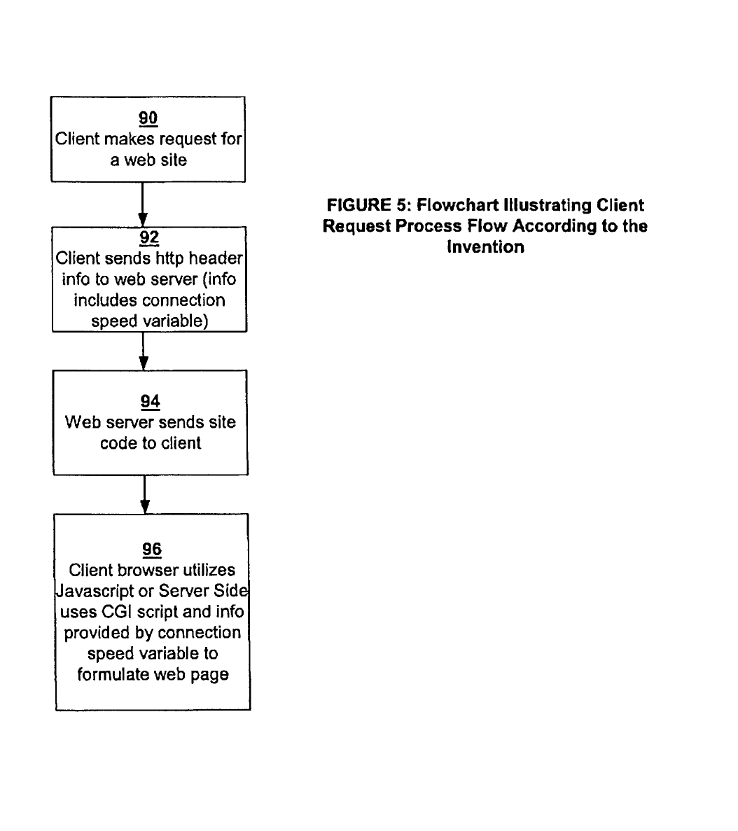

FIG. 5 is a flowchart illustrating the client request process of the present invention. In one embodiment, the present invention utilizes a header associated with the request to communicate the connection speed determined by the client. In most systems headers include standard environment variables. Each server will implement the majority of environment variables consistently. However, there may be variations or additional variables that can be added. Some of the standard CGI variables, for example, include content type and length, gateway interface ID, path information, remote host and address, server port, and the name/version of the HTTP server and protocol used by the request. In the present invention, the variable relating to connection speed may be an additional variable added to the header. At step 90, the client makes a request for a web site. The client sends the http header information, including the connection speed variable, to the web server, step 92. The web server sends the web site page to the client at step 94. The client browser JavaScript or the server side CGI script or server side Java servlet uses the connection speed variable to formulate the web page being requested at shown as step 96.

Additionally, the client machine may include means for storing web site IDs such that the client machine remembers which sites have been chosen to receive the connection speeds and continue to send the connection speeds upon future requests. For example, the client machine could be forced to save the connection speed in a “cookie” in the cookie cache of the browser. Rather than sending the connection speed information in the header, it could be included in a cookie sent to the browser. The cookie protocol is well known to the art and is described in RFC 2109 of the IETF. According to the cookie protocol, whenever a request is made to a server a particular DNS domain, the contents of the cookie cache which are applicable to the domain are forwarded to the server. Thus, setting the connection speed in a cookie is a good choice where the benchmarking server and web server are in the same DNS domain.

One of ordinary skill will appreciate that the present invention provides a client-server system with significantly more control over how a web site or page is received by the client machine. Using the header variable, the client machine can receive the most suitable version of a web site. For example, the web server upon receiving the connection speed can dynamically select among URLs to several different versions of the same graphic. Clients with slow connection speeds would receive a web page with embedded URLs to highly compressed graphics while those having high connection speeds could receive a web page with embedded URLs to high quality versions of the same graphics. Similarly, URLs to still pictures versus video, monoaural sound vs. stereo sound and so forth could be made.

Also, the present invention provides the additional advantage of allowing web developers to know what type of page would best serve their users or clients. Currently, web masters do not know the speeds with which their audience is connecting. As web clients connect to the web site, the connection speed information can be collected and stored. Thus, a statistical record of the representative connection speeds can be obtained. This information could be quite useful to web developers as the web developers can develop web sites suitable for different users. The web developer will be able to design and thus automatically serve clients suitable pages, i.e. high or low bandwidth versions, or even “web clipping” versions for wireless/handheld internet devices of the same web site of web page.

As discussed above, the connection speed information can be sent to the web server in an HTTP header construct according to the present invention. The media object and control information are included in a GET request. Control information is located in the header and includes information such as the IP address. The connection speed variable can be added to the header block to communicate the connection speed to the web server. The web server reads this information and the server responds with the version of the web site or page most suitable for the client platform.

The HTTP request header that will be sent from the client to the server might look like the following:

HTTP/1.0 200 OK

Date: Thursday, Oct. 31, 1996 17:25:32 GMT

Server: NCSA/1.3

MIME-version: 1.0

Last-Modified: Wednesday, Oct. 30, 1996 10:12:23 GMT

Content-type: text/html

Content-length: 89

Connection-Speed: 28.8 kbps

As noted above, the inventive mechanism is preferably implemented in a web browser. Although not meant to be limiting, the above-described functionality is preferably implemented as standalone native code or, alternatively, as a Java applet or application. In another embodiment of the invention, the benchmarking process is not initiated at the client, but rather by the web server. Upon an initial request by a client which lacks the connection speed information either in the header information or in a cookie, the client is redirected to the benchmarking server. Redirection to a different web server is a process well known to the art. After the connection speed is benchmarked, the benchmarking server sets the value for connection speed either as a parameter in the query string portion of an HTTP redirect request back to the web server or in a cookie in the cookie cache. If the benchmarking server is in a different DNS domain than the web server, the connection speed information would be transmitted in the redirect header. According to the cookie protocol, only servers in the same DNS domain would receive cookies set by other servers in that domain. In either case, the client is redirected back to the web server. In this second redirect, the web server is provided the connection speed data. If the benchmarking server was in a different DNS domain and the connection speed data was nonetheless desired to be stored as a cookie, once in possession of the connection speed data, the cookie could be set by the web server.

If the connection speed data is sent in the form of a cookie, the cookie data residing on the client side is typically in a file called cookies.txt. Upon contacting a server in a particular DNS domain, the client searches its cookie file for cookie data which is pertinent to that DNS domain. The cookie file is updateable so that when a user changes his mode of connection to the internet, e.g., dial in modem vs. cable modem vs. LAN connection, the cookie can be updated accordingly. For example, a change in cookie data from an original 28.8 K connection to a 56.6 K is shown below, after a new benchmarking session with the benchmarking server. An example of what might be stored in the cookie.txt cookies file on the client side that might be accessed:

www.ibm.com TRUE/FALSE 1041310962 connection-speed 28.8 k

a subsequent connection to the Internet using an alternate means, say at 56.6 K, would be a browser event according to the terminology of the invention. A new benchmarking session with the benchmarking server would determine the client connection speed, and the cookie above would changed to look like:

www.ibm.com TRUE/FALSE 1041310962 connection-speed 56.6 k

According to the invention, a browser event which would invoke the process described above would include the initial loading of the browser, an new connection to a new web site, a new connection to a server in a different DNS domain or a new connection to the Internet itself. Those skilled in the art would recognize that these events are exemplary, and that other events which would reasonably be expected to cause a change in the connection speed of the client could be used to trigger a new benchmarking session.

In one preferred embodiment, the above-described functionality is implemented in software executable in a processor, namely, as a set of instructions (program code) in a code module resident in the random access memory of the computer. Until required by the computer, the set of instructions may be stored in another computer usuable medium, for example, in a hard disk drive, or in a removable memory such as an optical disk (for eventual use in a CD ROM) or floppy disk (for eventual use in a floppy disk drive). Furthermore, the above described functionality may be sent via a computer usuable transmission medium such as the Internet or other computer network.

In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Further, as used herein, a Web “client” should be broadly construed to mean any computer or component thereof directly or indirectly connected or connectable in any known or later-developed manner to a computer network, such as the Internet. The term Web “server” should also be broadly construed to mean a computer, computer platform, an adjunct to a computer or platform, or any component thereof. Of course, a “client” should be broadly construed to mean one who requests or gets the file, and “server” is the entity which downloads the file.

Moreover, the use of a web browser for implementing this invention is not a limitation. The inventive technique may be implemented in any web client application that communicates with a web or HTTP server. Having thus described the invention, what we claim as new and desire to secure by Letters Patent is set forth in the following claims.

1. A method of customizing performance of a browser for a given network connection of a user, comprising the steps of:
upon a browser event, issuing a request to a benchmarking server;
returning given data from a session between the benchmarking server and the browser;
using the given data to calculate connection speed data; and
passing the connection speed data in a client request to a web server.

2. The method as described in claim 1 wherein the connection speed data is passed in a header of the client request.

3. The method as described in claim 1 wherein the request to a benchmarking server is a security certificate.

4. The method as described in claim 1 wherein the given data includes a test file.

5. The method as described in claim 1 wherein the given data includes the size of the test file.

6. The method as described in claim 5 further including generating a start time stamp of when the given data is sent.

7. The method as described in claim 6 wherein the start time stamp is generated by the benchmarking server.

8. The method as described in claim 6 further including generating an end time stamp of when the given data is received by the user.

9. The method as described in claim 8 wherein the start and end time stamps are used to calculate connection speed data.

10. The method as described in claim 8 wherein the size of the test file is used to calculate connection speed data.

11. The method as described in claim 1 further including calculating the test file size at the browser after returning the given data from the benchmarking server to the browser.

12. The method as described in claim 1 further including defining a variable to be given the value of the connection speed.

13. A method of serving a page from a server, comprising:
upon a browser event, issuing a request to a benchmarking server;
returning given data from the benchmarking server to the browser;
using the given data to calculate connection speed data;
passing the connection speed data in a client request to a server; and
returning a given page conforming to the connection speed data by the server.

14. The method as described in claim 13 wherein the connection speed data is passed in a cookie associated with a client request.

15. The method as described in claim 13 wherein the given data includes a time stamp of when the given data is sent.

16. The method as described in claim 13 wherein the passing of the connection speed data in a client request further includes passing a variable having the value of the connection speed.

17. A browser computer program product in a computer readable medium, comprising:
code for issuing a request to a benchmarking server;
code responsive to given data returned from the benchmarking server for calculating connection speed data; and
code for inserting the connection speed data in a client request to a web server.

18. The browser of claim 17 further including code for defining a variable having a value equal to the connection speed data.

19. The browser of claim 17 wherein the given data returned from the benchmarking server includes a time stamp of when the data was sent.

20. The browser of claim 17 further code for defining a time stamp of when the given data was received by the browser.

21. A web server computer program product in a computer readable medium comprising:
code for parsing a client request from a browser for connection speed data;
code responsive to finding connection speed data for selecting an appropriate web page to the browser; and
code responsive to an absence of connection speed data for redirecting the browser to a benchmarking server.

22. The web server as recited in claim 21, further comprising code for collecting connection speed data from a plurality of clients for building a database of connection speed data of clients of the web server.

23. A benchmarking server computer program product in a computer readable medium, comprising:
code for receiving a request for benchmarking a browser at a client;
code for benchmarking the client; and
code for sending data relating to connection speed of the client to be stored at the client.

24. The benchmarking server as recited in claim 23, further comprising:
code for receiving a redirect request from a web server; and
code for redirecting the client to the web server once benchmarking is complete.

25. A browser system including memory and processor, comprising:
means for issuing a request to a benchmarking server;
means responsive to given data returned from the benchmarking server for calculating connection speed data; and
means for inserting the connection speed data in a client request to a web server.

26. A web server system including processor and memory, comprising:
means for parsing a client request from a browser for connection speed data;
means responsive to finding connection speed data for selecting an appropriate web page to the browser; and
means responsive to an absence of connection speed data for redirecting the browser to a benchmarking server.

27. The web server as recited in claim 26, further comprising means for collecting connection speed data from a plurality of clients for building a database of connection speed data of clients of the web server.

28. A benchmarking server system, comprising:
means for receiving a request for benchmarking a browser at a client;
means for benchmarking the client; and
means for sending data relating t o connection speed of the client to be stored at the client.

29. The benchmarking server as recited in claim 28, further comprising:
means for receiving a redirect request from a web server; and
means for redirecting the client to the web server once benchmarking is complete.
